(19) United States
(12) Patent Application Publication
(10) Pub. No.: US 2024/0142627 A1
(43) Pub. Date: May 2, 2024

(54) Method for Operating a Gated Camera, Control Device for Carrying Out Such a Method, Camera Device Comprising Such a Control Device, and Motor Vehicle Comprising Such a Camera Device

(71) Applicant: Daimler Truck AG, Leinfelden-Echterdingen (DE)

(72) Inventor: Fridtjof STEIN, Ostfildern (DE)

(21) Appl. No.: 18/548,787

(22) PCT Filed: Mar. 2, 2022
(86) PCT No.: PCT/EP2022/055199

§ 371 Date: Sep. 1, 2023

(30) Foreign Application Priority Data
Mar. 5, 2021 (DE) 10 2021 001 175.9

(51) Int. Cl. G01S 17/89; G01S 17/18; G01S 17/931

(52) U.S. Cl. CPC G01S 17/89; G01S 17/18; G01S 17/931

(57) ABSTRACT

A method for operating a gated camera having an illumination device and an optical sensor. A control of the illumination device and the optical sensor is coordinated. At least one first coordinated control is associated with a first visible distance range and a first image is obtained by the at least one first coordinated control. The first image is used to search for objects. A first object distance is estimated between a found object and the optical sensor. A second coordinated control of the illumination device and the optical sensor is determined such that the first object distance is within a second visible distance range associated with the second coordinated control. A second image of the second visible distance range is recorded with the optical sensor by using the second coordinated control upon illumination by the illumination device. A second object distance is determined by using the second image.

### BACKGROUND AND SUMMARY OF THE INVENTION

The invention relates to a method for operating a gated camera, a control device for carrying out such a method, a camera device comprising such a control device, and a motor vehicle comprising such a camera device.

Methods are known for the precise determination of distances by means of a gated camera. The disadvantage of these methods is that object recognition is only possible poorly and/or very inaccurately.

Furthermore, methods are known in which the gated camera is controlled in such a way that a very precise and robust object recognition is made possible by means of the gated camera. The disadvantage of these methods is that they only allow a comparatively imprecise determination of the distance between the detected object and the gated camera.

The object of the invention is to create a method for operating a gated camera, a control device for carrying out such a method, a camera device comprising such a control device, and a motor vehicle comprising such a camera device, wherein the disadvantages mentioned are at least partially eliminated, preferably avoided.

The object is achieved in particular by creating a method for operating a gated camera which has at least one illumination device and an optical sensor, wherein a control of the at least one illumination device and of the optical sensor are coordinated with one another in terms of time. At least one first visible distance range is associated with at least one first coordinated control, wherein a first image is obtained by means of the at least one first control. The first image is used to search for objects, wherein, if an object is found, a first object distance is estimated as the distance between the found object and the optical sensor. Thereafter, a second coordinated control of the at least one illumination device and the optical sensor is determined such that the first object distance is within a second visible distance range associated with the second coordinated control. In addition, the second coordinated control is determined such that the second visible distance range is smaller than the first visible distance range. By means of the second coordinated control, a second image of the second visible distance range is recorded with the optical sensor upon illumination by means of the at least one illumination device. Lastly, a second object distance is determined by means of the second image.

Advantageously, an object detection, especially of small objects at a great distance, can be carried out very precisely and robustly in the first image. Furthermore, it is advantageous that a distance calculation can be carried out very precisely in the second image. Preferably, a method according to the German laid-open application DE 10 2020 002 994 A1 is used for the distance calculation. Preferably, the first object distance is estimated using a method according to the German laid-open application DE 10 2020 002 994 A1. Alternatively or additionally, the second object distance is preferably determined by means of a method according to the German laid-open application DE 10 2020 002 994 A1.

In particular, in the case of the gated camera, a near boundary and a far boundary of a visible distance range in an image of the gated camera become blurrier and cannot be located as precisely, the further the near boundary and the far boundary of the visible distance range are spatially separated from each other. In a method according to the German laid-open application DE 10 2020 002 994 A1, the near boundary and the far boundary of the visible distance range are used to perform a distance determination. Thus, the precision of the localization of the near boundary and the far boundary of the visible distance range in the image of the gated camera has a direct influence on the accuracy of the distance determination.

Furthermore, it is particularly true that object detection by means of an image from the gated camera can be performed more precisely and robustly, the further the near boundary and the far boundary of the visible distance range are spatially separated from each other.

Preferably, the first visible distance range and the second visible distance range are selected such that the first visible distance range is much larger than the second visible distance range. This is because the object detection becomes better when the visible distance range which is used for object detection becomes larger. By contrast, distance determination becomes more accurate when the visible distance range used for distance determination becomes smaller.

The method for generating images by means of a temporally coordinated control of at least one illumination device, and an optical sensor is in particular known as a gated imaging method; in particular, the optical sensor is a camera which is only sensitively in a specific, limited time range, this being referred to as “gated control”. The at least one illumination device, which is in particular a first illumination device and/or a second illumination device, is also correspondingly controlled in time only in a specific, selected time interval in order to illuminate an object-side scene.

In the following, the first illumination device and/or the second illumination device are referred to instead of the at least one illumination device. If only one illumination device is used, this can be referred to as the first illumination device. If two illumination devices are used, one of the two illumination devices is referred to as the first illumination device and the other is referred to as the second illumination device. It is also possible that more than two illumination devices are used.

In particular, a predefined number of light pulses are emitted by the first illumination device and/or the second illumination device, preferably with a duration between 5 ns and 20 ns. The beginning and the end of the exposure of the optical sensor is coupled to the number and duration of the emitted light pulses. As a result, a specific visible distance range can be detected by the optical sensor through the temporal control of, on the one hand, the first illumination device and/or the second illumination device, and, on the other hand, the optical sensor with a correspondingly defined local position, i.e., in particular a specific distance of a near and a far limit of the visible distance range from the optical sensor. A local position of the optical sensor and the at least one illumination device is known from the design of the gated camera. Preferably, a local distance between the at least one illumination device and the optical sensor is also known and small compared to the distance of the at least one illumination device or the optical sensor to the visible distance range. Thus, in the context of the present technical teaching, a distance between the optical sensor and an object is equal to a distance between the gated camera and the object.

The visible distance range is the—object-side—range in three-dimensional space that is imaged in a two-dimensional image on an image plane of the optical sensor by the number and duration of the light pulses of the first illumination device and/or the second illumination device in conjunction with the start and end of the exposure of the optical sensor by means of the optical sensor in a two-dimensional image on an image plane of the optical sensor.

As far as “object side” is mentioned here and in the following, an area in real space is addressed. As far as “on the image side” is mentioned here and in the following, an area on the image plane of the optical sensor is addressed. The visible distance range is given here on the object side. This corresponds to an image-side area on the image plane assigned by the imaging laws and the temporal control of the first illumination device and/or the second illumination device and the optical sensor.

Depending on the start and end of the exposure of the optical sensor after the start of the illumination by the first illumination device and/or the second illumination device, light pulse photons strike the optical sensor. The further the visible distance range is from the first illumination device and/or the second illumination device and the optical sensor, the longer the time duration is until a photon reflected in this distance range hits the optical sensor. Therefore, the time interval between the end of the illumination and the beginning of the exposure increases, the further away the visible distance range is from the first illumination device and/or the second illumination device and from the optical sensor.

Thus, according to one embodiment of the method, it is possible in particular to define the position and the spatial width of the visible distance range, in particular a distance between the near boundary and the far boundary of the visible distance range, by a corresponding suitable selection of the temporal control of the first illumination device and/or the second illumination device on the one hand and of the optical sensor on the other hand.

In a preferred embodiment of the method, the visible distance range is predetermined, and on this basis the time coordination of the first illumination device and/or the second illumination device on the one hand and of the optical sensor on the other hand is predetermined accordingly.

In a preferred embodiment, the first illumination device and/or the second illumination device is a laser. Alternatively or additionally, the optical sensor is preferably a camera.

According to a development of the invention, it is provided that—as the at least one first coordinated control—a first coordinated control of the first illumination device and of the optical sensor is associated with a first visible distance range. Additionally—again as the at least one first coordinated control—a second first coordinated control of a second illumination device and of the optical sensor is associated with a second first visible distance range. The first visible distance range and the second first visible distance range at least partially overlap and the overlap forms the first visible distance range. By means of the first coordinated control, a first image of the first visible distance range is recorded with the optical sensor upon illumination by means of the first illumination device. Furthermore, by means of the second first coordinated control, a second first image of the second first visible distance range is recorded with the optical sensor upon illumination by means of the second illumination device. The first image and the second first image form the first image.

Advantageously, due to the combination of the first image and the second first image to form the first image, a robust and accurate object detection can be performed in the first image.

In particular, the second visible distance range is smaller than the first visible distance range and/or the second first visible distance range.

In particular, the second image of the second visible distance range is recorded with the optical sensor upon illumination by means of the first illumination device. Alternatively, in particular the second image of the second visible distance range is recorded with the optical sensor upon illumination by means of the second illumination device.

In a preferred embodiment, the first illumination device and the second illumination device—for producing the first image—and the first illumination device—for producing the second image—are activated one after the other in time.

In a further preferred embodiment, the first illumination device and the second illumination device—for producing the first image—and the second illumination device—for producing the second image—are activated one after the other in time.

According to a development of the invention, it is provided that the first illumination device and the second illumination device are spatially distanced from one another, wherein image information is searched for in the first image generated as a differential image of the first image and the second first image. At least one object is found by means of the image information found in the first image.

Advantageously, a first shadow of an object is cast by means of the first illumination device and is visible in the first image. Since the first illumination device and the second illumination device are spatially distanced from each other, a second shadow of the object is cast, which differs from the first shadow cast, is produced by means of the second illumination device and is visible in the second first image. Advantageously, the difference between the first shadow cast and the second shadow cast is represented as image information in the first image, which results as the difference between the first image and the second first image. This image information, in particular the difference between the first shadow cast and the second shadow cast, can advantageously be detected easily, quickly and robustly in the first image.

According to a development of the invention, it is provided that a third coordinated control of the at least one illumination device and the optical sensor is determined such that the first object distance is within a third visible distance range associated with the third coordinated control. In addition, the third coordinated control is determined such that the third visible distance range is smaller than the first visible distance range. By means of the third coordinated control, a third image of the third visible distance range is recorded with the optical sensor upon illumination by means of the at least one illumination device. Lastly, a third object distance is determined by means of the third image.

Advantageously, a distance between the found object and the optical sensor can be precisely determined on the basis of the third image, in particular upon illumination by means of the second illumination device.

In particular, the third visible distance range is smaller than the first visible distance range and/or the second first visible distance range.

Preferably, the object-side visible distance ranges, which are recorded in the second and the third image, are illuminated with different illumination devices. Preferably, the illumination devices by means of which the object-side visible distance ranges are illuminated in the second and the third image are not identical.

In a preferred embodiment, the second image is recorded with the optical sensor upon illumination by the first illumination device. In addition, the third image is recorded with the optical sensor upon illumination by means of the second illumination device.

In a further preferred embodiment, the second image in particular is recorded with the optical sensor upon illumination by means of the second illumination device. In addition, the third image is recorded with the optical sensor upon illumination by means of the first illumination device.

In a further embodiment, the second image in particular is recorded with the optical sensor upon illumination by means of the first illumination device. In addition, the third image is recorded with the optical sensor upon illumination by means of the first illumination device.

In a further embodiment, the second image in particular is recorded with the optical sensor upon illumination by means of the second illumination device. In addition, the third image is recorded with the optical sensor upon illumination by means of the second illumination device.

Preferably, the third object distance is determined by means of a method according to the German laid-open application DE 10 2020 002 994 A1.

According to a development of the invention, it is provided that in a first time sequence the first image, in particular the first image and thereafter the second first image, and the second image are recorded, wherein the second object distance is determined. In a second time sequence following the first time sequence, a further first image, in particular a further first first image and thereafter a further second first image, and the third image are recorded, wherein the third object distance is determined.

Advantageously, only one illumination device is required for each image selected from the second image and the third image to illuminate the respective visible distance range, wherein different illumination devices are preferably used for the second image and the third image. This allows the first illumination device and the second illumination device to cool down between their respective control, whereby a constant power of the first illumination device below the second illumination device can be ensured.

In a preferred embodiment, the first illumination device and the second illumination device—for producing the first image—, the first illumination device—for producing the second image—, the first illumination device and the second illumination device—for producing the further first image—and the second illumination device—for producing the third image—are activated one after the other in time.

In a further preferred embodiment, the first illumination device and the second illumination device—for producing the first image—, the second illumination device—for producing the second image—, the first illumination device and the second illumination device—for producing the further first image—and the first illumination device—for producing the third image—are activated one after the other in time.

In a further preferred embodiment, the first illumination device and the second illumination device—for producing the first image—, the first illumination device—for producing the second image—, the second illumination device and the first illumination device—for producing the further first image—and the second illumination device—for producing the third image—are activated one after the other in time.

In a further embodiment, the first illumination device and the second illumination device—for producing the first image—, the first illumination device—for producing the second image—, the first illumination device and the second illumination device—for producing the further first image—and the first illumination device—for producing the third image—are activated one after the other in time.

In a further embodiment, the first illumination device and the second illumination device—for producing the first image—, the second illumination device—for producing the second image—, the first illumination device and the second illumination device—for producing the further first image—and the second illumination device—for producing the third image—are activated one after the other in time.

In a further embodiment, the first illumination device and the second illumination device—for producing the first image—, the first illumination device—for producing the second image—, the second illumination device and the first illumination device—for producing the further first image—and the first illumination device—for producing the third image—are activated one after the other in time.

In a further embodiment, the first illumination device and the second illumination device—for producing the first image—, the second illumination device—for producing the second image—, the second illumination device and the first illumination device—for producing the further first image—and the second illumination device—for producing the third image—are activated one after the other in time.

In a further embodiment, the first illumination device and the second illumination device—for producing the first image—, the second illumination device—for producing the second image—, the second illumination device and the first illumination device—for producing the further first image—and the first illumination device—for producing the third image—are activated one after the other in time.

According to a development of the invention, it is provided that in a third time sequence the first image, in particular the first image, and then the second first image, the second image and the third image are recorded. The second object distance, the third object distance and a fourth object distance are determined here, wherein the fourth object distance is determined from the second object distance and the third object distance.

Advantageously, the combination of the second object distance and the third object distance can be used to determine a more precise distance, in particular the fourth object distance, between the found object and the optical sensor.

In particular, the fourth object distance is calculated as an average value, especially as a weighted average value, from the second object distance and the third object distance.

In a preferred embodiment, the first illumination device and the second illumination device—for producing the first image—, the first illumination device—for producing the second image—, and the second illumination device—for producing the third image—are activated one after the other in time.

In a further preferred embodiment, the first illumination device and the second illumination device—for producing the first image—, the second illumination device—for producing the second image—, and the first illumination device—for producing the third image—are activated one after the other in time.

In a further embodiment, the first illumination device and the second illumination device—for producing the first image—, the first illumination device—for producing the second image—, and the first illumination device—for producing the third image—are activated one after the other in time.

In a further preferred embodiment, the first illumination device and the second illumination device—for producing the first image—, the second illumination device—for producing the second image—, and the second illumination device—for producing the third image—are activated one after the other in time.

According to a development of the invention, it is provided that the second and/or the third visible distance range are selected in such a way that the second and/or the third visible distance range are completely within the first visible distance range, in particular the first and/or the second first visible distance range.

The object is also achieved by creating a control device which is set up to carry out a method according to the invention or a method according to one or more of the embodiments described above. The control device is preferably designed as a computing device, particularly preferably as a computer, or as a control device, particularly as a control device of a motor vehicle. The advantages already explained in conjunction with the method arise in particular in conjunction with the control device.

The control device is preferably set up to be operatively connected to the gated camera, in particular to the at least one illumination device and the optical sensor, and is set up for their respective control.

The object is also achieved by creating a camera device comprising a gated camera having at least one illumination device and an optical sensor, and a control device according to the invention or a control device according to one or more of the embodiments described above. In conjunction with the camera device, the advantages which have already been explained in conjunction with the method and the control device arise in particular.

The control device is preferably operatively connected to the gated camera, in particular to the at least one illumination device and the optical sensor, and is set up for their respective control.

The object is also achieved by creating a motor vehicle comprising a camera device according to the invention or a camera device according to one or more of the embodiments described above. In particular, the advantages already explained in conjunction with the method, the control device and the camera device arise in conjunction with the motor vehicle.

In an advantageous embodiment, the motor vehicle is designed as a heavy goods vehicle. However, it is also possible that the motor vehicle is a passenger car, a commercial vehicle or another motor vehicle.

The invention is explained in greater detail below with reference to the drawings.

### BRIEF DESCRIPTION OF THE DRAWINGS

FIG. 1 shows a schematic representation of an exemplary embodiment of a motor vehicle and an object in a first visible distance range;

FIG. 2 shows a schematic representation of the exemplary embodiment of the motor vehicle and the object in a second and/or a third visible distance range;

FIG. 3 shows a schematic representation of the exemplary embodiment of the motor vehicle and the object in the first visible distance range;

FIG. 4 shows a flowchart of a first exemplary embodiment of a method for operating a gated camera;

FIG. 5 shows a flowchart of a second exemplary embodiment of the method for operating the gated camera; and

FIG. 6 shows a flowchart of a third exemplary embodiment of the method for operating the gated camera.

### DETAILED DESCRIPTION OF THE DRAWINGS

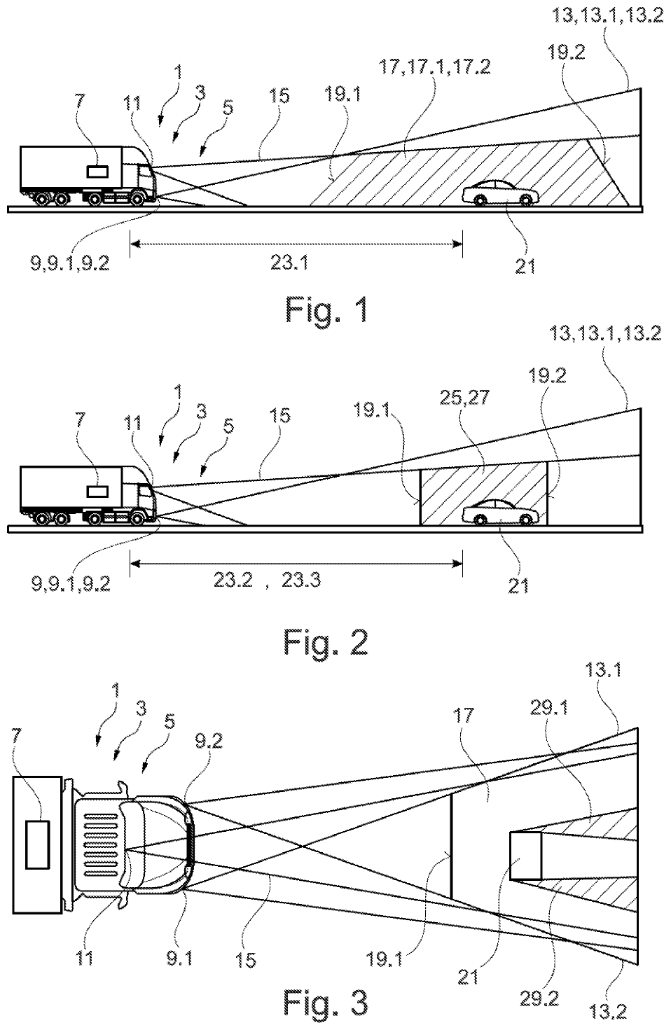

FIG. 1 shows a schematic representation of an exemplary embodiment of a motor vehicle 1 comprising a camera device 3. The camera device 3 has a gated camera 5 and a control device 7. Furthermore, the gated camera 5 comprises at least one illumination device 9, preferably a first illumination device 9.1 and a second illumination device 9.2, and an optical sensor 11. The at least one illumination device 9 is preferably a laser, in particular a VSCE laser. The optical sensor 11 is preferably a camera. The control device 7 is shown here only schematically and is connected to the gated camera 5, in particular the at least one illumination device 9 and the optical sensor 11, in a manner not explicitly shown and is set up for their respective control. FIG. 1 shows in particular an illumination frustum 13 of the at least one illumination device 9 and an observation region 15 of the optical sensor 11. Preferably, the first illumination device 9.1 generates a first illumination frustum 13.1 and the second illumination device 9.2 generates a second illumination frustum 13.2.

Shown by hatching is also a first visible distance range 17, which is a subset of the illumination frustum 13, in particular the first illumination frustum 13.1 of the first illumination device 9.1, and of the second illumination frustum 13.2 of the second illumination device 9.2, and the observation region 15 of the optical sensor 11. A near boundary 19.1 and a far boundary 19.2 of the first visible distance range 17 are drawn obliquely. This visually indicates that the near boundary 19.1 and the far boundary 19.2 of the first visible distance range 17 are blurred in a first image of the gated camera 5 and therefore cannot be precisely located and/or determined. In particular, in the case of the gated camera 5, the near boundary 19.1 and the far boundary 19.2 of a visible distance range become more blurred in an image of the gated camera 5, the further the near boundary 19.1 and the far boundary 19.2 of the visible distance range are spatially distanced from one another.

An object 21, in particular a passenger car, is located in the first visible distance range 17. A first object distance 23.1 is estimated by means of the first image of the gated camera 5. Preferably, the first object distance 23.1 is estimated by means of the near boundary 19.1 and the far boundary 19.2 of the first visible distance range 17, in particular by means of the imprecisely determinable positions of the near boundary 19.1 and the far boundary 19.2 of the first visible distance range 17 in the first image.

Preferably, the first visible distance range 17 is a region of overlap of a first visible distance range 17.1 and a second first visible distance range 17.2. Preferably, the first first visible distance range 17.1 is associated with a first coordinated control of the first illumination device 9.1 and the optical sensor 11. Preferably, the second first visible distance range 17.2 is associated with a second first coordinated control of the second illumination device 9.2 and the optical sensor 11.

FIG. 2 shows a schematic representation of the exemplary embodiment of the motor vehicle 1 with a camera device 3, wherein the object 21 is arranged in a second visible distance range 25. The second visible distance range 25 is associated with a second coordinated control of the at least one illumination device 9, preferably the first illumination device 9.1, and the optical sensor 11.

Identical and functionally identical elements are provided with the same reference signs in all figures, and therefore reference is made to the previous description in each case.

A near boundary 19.1 and a far boundary 19.2 of the second visible distance range 25 are drawn vertically. This visually indicates that the near boundary 19.1 and the far boundary 19.2 of the second visible distance range 25 can be determined almost exactly in a second image of the gated camera 5.

Preferably, the second visible distance range 25 is completely within the first visible distance range 17.

A second object distance 23.2 is determined by means of the second image of the gated camera 5. Preferably, the second object distance 23.2 is determined by means of the near boundary 19.1 and the far boundary 19.2 of the second visible distance range 25, in particular by means of the almost exactly determinable positions of the near boundary 19.1 and the far boundary 19.2 of the second visible distance range 25.

Alternatively, the object 21 is arranged in a third visible distance range 27. The third visible distance range 27 is associated with a third coordinated control of an illumination device 9 of the at least two illumination devices 9, preferably the second illumination device 9.2, and the optical sensor 11.

Preferably, different illumination devices 9 are used for the illumination to produce the second image and the third image. Alternatively, the same illumination device 9, in particular the first illumination device 9.1 or the second illumination device 9.2, can be used for the illumination to produce the second image and the third image.

A near boundary 19.1 and a far boundary 19.2 of the third visible distance range 27 are drawn vertically. This visually indicates that the near boundary 19.1 and the far boundary 19.2 of the third visible distance range 27 can be determined almost exactly in a third image of the gated camera 5.

A third object distance 23.3 is determined by means of the third image of the gated camera 5. Preferably, the third object distance 23.3 is determined by means of the near boundary 19.1 and the far boundary 19.2 of the third visible distance range 27, in particular by means of the almost exactly determinable positions of the near boundary 19.1 and the far boundary 19.2 of the third visible distance range 27.

FIG. 3 shows a schematic representation of the exemplary embodiment of the motor vehicle 1 with a camera device 3 in a plan view, wherein the first illumination device 9.1 and the second illumination device 9.2 are preferably distanced from one another. The object 21 is arranged in the first visible distance range 17.

The object 21 casts a first shadow 29.1 upon illumination by means of the first illumination device 9.1. Furthermore, the object 21 casts a second shadow 29.2 upon illumination by means of the second illumination device 9.2. In a preferred exemplary embodiment, the object 21 is detected in the first image of the gated camera 5 by means of the first shadow cast 29.1 and the second shadow cast 29.2, and in particular an object detection is based on the search for at least one shadow cast 29.

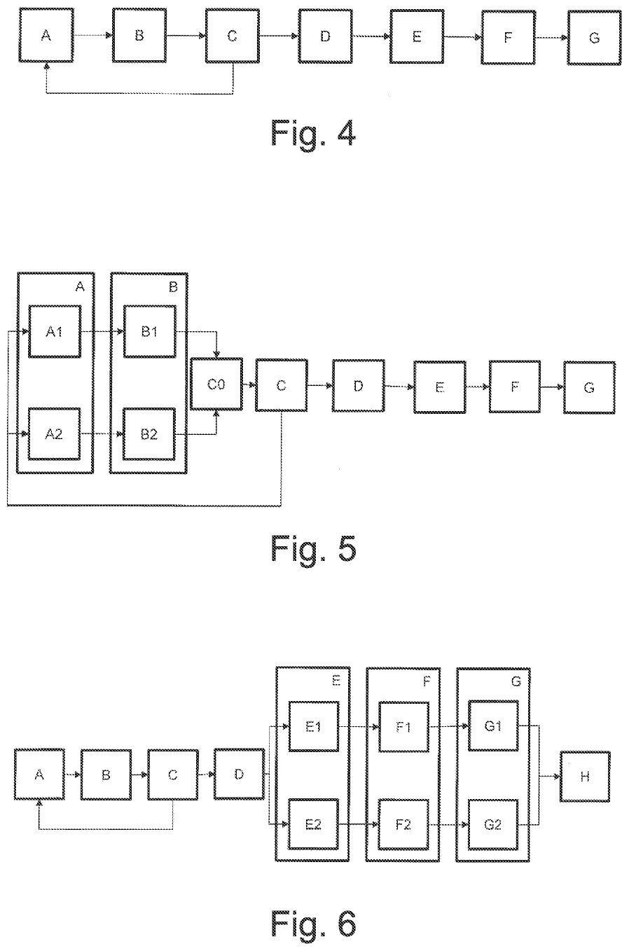

FIG. 4 shows a flowchart of a first exemplary embodiment of a method for operating the gated camera 5.

In a step A, a first coordinated control of the at least one illumination device 9 and of the optical sensor 11 is determined, wherein the first visible distance range 17 is associated with the first coordinated control.

In a step B, the first image is obtained by means of the first coordinated control.

In a step C, the first image is used to search for objects 21. If no object 21 is found in step C, the method starts again with step A.

If an object 21 is found in step C, the first object distance 23.1 is estimated in step D as the distance between the found object 21 and the optical sensor 11.

In a step E, a second coordinated control of the at least one illumination device 9 and the optical sensor 11 is determined in such a way that the first object distance 23.1 is within the second visible distance range 25, which is associated with the second coordinated control. Furthermore, the second coordinated control is determined such that the second visible distance range 25 is smaller than the first visible distance range 17.

In a step F, the second image is recorded with the optical sensor 11 by means of the second coordinated control upon illumination by means of the at least one illumination device 9.

In a step G, the second object distance 23.2 is determined by means of the second image. Advantageously, the second object distance 23.2 is more precise than the first object distance 23.1.

FIG. 5 shows a flowchart of a second exemplary embodiment of the method for operating the gated camera 5.

Step A is divided into a step A1 and a step A2. In step A1, the first coordinated control of the first illumination device 9.1 and of the optical sensor 11 is determined, wherein the first visible distance range 17.1 is associated with the first coordinated control. In step A2, the second first coordinated control of the second illumination device 9.2 and of the optical sensor 11 is determined, wherein the second first visible distance range 17.2 is associated with the second first coordinated control. The first visible distance range 17.1 and the second first visible distance range 17.2 are selected such that the first visible distance range 17.1 and the second first visible distance range 17.2 at least partially overlap and the overlap defines the first visible distance range 17.

Step B is divided into a step B1 and a step B2. In step B1, the first image is recorded with the optical sensor 11 by means of the first coordinated control upon illumination by means of the first illumination device 9.1. In step B2, the second first image is recorded with the optical sensor 11 by means of the second first coordinated control upon illumination by means of the second illumination device 9.2.

Alternatively, in step A1, the first coordinated control of the second illumination device 9.2 and of the optical sensor 11 is determined, wherein the first visible distance range 17.1 is associated with the first coordinated control. In step A2, the second first coordinated control of the first illumination device 9.1 and of the optical sensor 11 is determined, wherein the second first visible distance range 17.2 is associated with the second first coordinated control. In addition, in step B1, the first image is recorded with the optical sensor 11 by means of the first coordinated control upon illumination by means of the second illumination device 9.2. In step B2, the second first image is recorded with the optical sensor 11 by means of the second first coordinated control upon illumination by means of the first illumination device 9.1.

In step C0, the first image is formed from the first image and the second first image. Preferably, the first image is generated as a differential image of the first image and the second first image.

If, in the step C0, the first image is preferably generated as a differential image of the first image and the second first image, then, in the step C, a search is preferably made for image information generated by the first shadow cast 29.1 and/or the second shadow cast 29.2. The object 21 is preferably found by means of the image information generated by the first shadow cast 29.1 and/or the second shadow cast 29.2.

Steps C to G are preferably carried out in the same way as in FIG. 4.

FIG. 6 shows a flowchart of a third exemplary embodiment of the method for operating the gated camera 5.

Steps A to D are preferably carried out analogously to FIG. 4.

Alternatively, steps A to D are preferably carried out analogously to FIG. 5.

Step E is divided into a step E1 and a step E2. In step E1, the second coordinated control of the first illumination device 9.1 and of the optical sensor 11 is determined, wherein the second visible distance range 25 is associated with the second coordinated control. In step E2, a third coordinated control of the second illumination device 9.2 and of the optical sensor 11 is determined, wherein a third visible distance range 27 is associated with the third coordinated control. Furthermore, the third coordinated control is determined such that the third visible distance range 27 is smaller than the first visible distance range 17.

The step F is divided into a step F1 and a step F2. In step F1, the second image is recorded with the optical sensor 11 by means of the second coordinated control upon illumination by means of the first illumination device 9.1. In step F2, the third picture is recorded with the optical sensor 11 by means of the third coordinated control upon illumination by means of the second illumination device 9.2.

Alternatively, in step E1, the second coordinated control of the second illumination device 9.2 and of the optical sensor 11 is determined, wherein the second coordinated control is associated with the second visible distance range 25. In step E2, a third coordinated control of the first illumination device 9.1 and of the optical sensor 11 is determined, wherein a third visible distance range 27 is associated with the third coordinated control. In addition, in step F1, the second image is recorded with the optical sensor 11 by means of the second coordinated control upon illumination by means of the second illumination device 9.2. In step F2, the third image is recorded with the optical sensor 11 by means of the third coordinated control upon illumination by means of the first illumination device 9.1.

Alternatively, in step E1, the second coordinated control of the first illumination device 9.1 and of the optical sensor 11 is determined, wherein the second coordinated control is associated with the second visible distance range 25. In step E2, a third coordinated control of the first illumination device 9.1 and of the optical sensor 11 is determined, wherein a third visible distance range 27 is associated with the third coordinated control. In addition, in step F1, the second image is recorded with the optical sensor 11 by means of the second coordinated control upon illumination by means of the first illumination device 9.1. In step F2, the third image is recorded with the optical sensor 11 by means of the third coordinated control with illumination by means of the first illumination device 9.1.

Alternatively, in step E1, the second coordinated control of the second illumination device 9.2 and of the optical sensor 11 is determined, wherein the second coordinated control is associated with the second visible distance range 25. In step E2, a third coordinated control of the second illumination device 9.2 and of the optical sensor 11 is determined, wherein a third visible distance range 27 is associated with the third coordinated control. In addition, in step F1, the second image is recorded with the optical sensor 11 by means of the second coordinated control upon illumination by means of the second illumination device 9.2. In step F2, the third image is recorded with the optical sensor 11 by means of the third coordinated control with illumination by means of the second illumination device 9.2.

The step G is divided into a step G1 and a step G2. In step G1, the second object distance 23.2 is determined by means of the second image. In step G2, the third object distance 23.3 is determined by means of the third image.

In a first time sequence, step B, in particular step B1, is carried out first, followed in time by step B2, in order to obtain the first image, in particular the first image, followed in time by the second first image. Alternatively, step B2 is carried out first, followed in time by step B1, in order to obtain the first image, in particular the second first image, and then in time the first image. Step F, in particular step F1, is then carried out in order to record the second image.

In particular, a first exemplary embodiment of the first time sequence comprises the steps A-B-C-D-E1-F1-G1.

In particular, a second exemplary embodiment of the first time sequence comprises the steps A1, A2-B1-B2-C0-C-D-E1-F1-G1.

In a second time sequence, step B is carried out first, in particular step B1 first and step B2 thereafter, to obtain the first image, in particular the first image and thereafter the second first image. After that, step F2 is carried out in order to record the third image.

In particular, a first exemplary embodiment of the second time sequence comprises the steps A-B-C-D-E2-F2-G2.

In particular, a second exemplary embodiment of the first time sequence comprises the steps A1, A2-B1-B2-C0-C-D-E2-F2-G2.

In a particularly preferred exemplary embodiment, the first time sequence and the second time sequence are carried out in alternation in time. The second object distance 23.2 is determined here after the first time sequence, and the third object distance 23.3 is determined after the second time sequence.

In a third time sequence, step B is carried out first, in particular step B1 first and step B2 thereafter, to obtain the first image, in particular the first image and thereafter the second first image. Then, step F1 is carried out to record the second image. Lastly, step F2 is carried out to take the third image. The fourth object distance is determined here from the second object distance 23.2 and the third object distance 23.3.

In particular, a first exemplary embodiment of the third time sequence comprises the steps A-B-C-D-E1, E2-F1-F2-G1, G2-H.

In particular, a second exemplary embodiment of the third time sequence comprises the steps A1, A2-B1-B2-C0-C-D-E1, E2-F1-F2-G1, G2-H.

1.-10. (canceled)

11. A method for operating a gated camera (5) having at least one illumination device (9) and an optical sensor (11), comprising:
a control of the at least one illumination device (9) and of the optical sensor (11) are coordinated with one another in terms of time;
at least one first coordinated control is associated with a first visible distance range (17);
a first image is obtained by means of the at least one first coordinated control;
the first image is used to search for objects (21);
when an object (21) is found, a first object distance (23.1) is estimated as a distance between the found object (21) and the optical sensor (11);
a second coordinated control of the at least one illumination device (9) and the optical sensor (11) is determined such that the first object distance (23.1) is within a second visible distance range (25) associated with the second coordinated control;
wherein the second visible distance range (25) is smaller than the first visible distance range (17);
a second image of the second visible distance range (25) is recorded with the optical sensor (11) by means of the second coordinated control upon illumination by means of the at least one illumination device (9); and
a second object distance (23.2) is determined by means of the second image.

12. A method according to claim 11, wherein:
a first visible distance range (17.1) is associated with a first coordinated control of a first illumination device (9.1) of the at least one illumination device (9) and of the optical sensor (11);
a second first coordinated control of a second illumination device (9.2) of the at least one illumination device (9) and of the optical sensor (11) is associated with a second first visible distance range (17.2);
the first visible distance range (17.1) and the second first visible distance range (17.2) at least partially overlap and a region of the overlap forms the first visible distance range (17);
a first image of the first visible distance range (17.1) is recorded with the optical sensor (11) by means of the first coordinated control upon illumination by means of the first illumination device (9.1);
a second first image of the second first visible distance range (17.2) is recorded with the optical sensor (11) by means of the second first coordinated control upon illumination by means of the second illumination device (9.2); and
the first image and the second first image form the first image.

13. The method according to claim 12, wherein:
the first illumination device (9.1) and the second illumination device (9.2) are spatially distanced from one another;
image information is searched for in the first image generated as a differential image of the first image and the second first image; and
at least one object (21) is found by means of the image information found in the first image.

14. The method according to claim 11, wherein:
a third coordinated control of an illumination device (9) of the at least one illumination device (9) and of the optical sensor (11) is determined such that the first object distance (17) is within a third visible distance range (27) associated with the third coordinated control;
the third visible distance range (27) is smaller than the first visible distance range (17);
a third image of the third visible distance range (27) is recorded with the optical sensor (11) by means of the third coordinated control upon illumination by means of the illumination device (9) of the at least one illumination device (9); and
a third object distance (23.3) is determined by means of the third image.

15. The method according to claim 14, wherein:
in a first time sequence, the first image and the second image are recorded;
the second object distance (23.2) is determined;
in a second time sequence following the first time sequence, a further first image and the third image are recorded; and
the third object distance (23.3) is determined.

16. The method according to claim 15, wherein:
in a third time sequence, the first image, the second image and the third image are recorded;
the second object distance (23.2), the third object distance (23.3) and a fourth object distance are determined; and
the fourth object distance is determined from the second object distance (23.2) and the third object distance (23.3).

17. The method according to claim 14, wherein the second visible distance range (25) and/or the third visible distance range (27) are completely within the first visible distance range (17).

18. A control device (7) configured to perform the method according to claim 11.

19. A camera device (3), comprising:
a gated camera (5) which has a first illumination device (9.1), a second illumination device (9.2), and an optical sensor (11); and
a control device (7) configured to perform the method according to claim 11.
